(19) United States
(12) Patent Application Publication
(10) Pub. No.: US 2026/0199839 A1
(43) Pub. Date: Jul. 16, 2026

(54) DEWATERER SYSTEMS AND METHODS

(71) Applicant: Thermal Energy Concepts LLC, Minnetonka, MN (US)

(72) Inventors: Kevin Friesth, Eugene, OR (US); Mark Cooper, Eugene, OR (US)

(21) Appl. No.: 19/446,074

(22) Filed: Jan. 12, 2026

Related U.S. Application Data
(60) Provisional application No. 63/743,909, filed on Jan. 10, 2025.

(51) Int. Cl. B01D 61/36

(52) U.S. Cl. CPC B01D 61/3641; B01D 2257/80; B01D 2311/1031; B01D 2311/2669; B01D 2313/205; B01D 2317/02

(57) ABSTRACT

Embodiments include a system including a distillation cell. The distillation cell may include a membrane and a jacketed wall. The jacketed wall may include a first jacket. The first jacket may include a first inner wall, a first outer wall, and a first fluted medium between the first inner wall and the first outer wall. The first fluted medium may form a first plurality of channels. Each channel may be defined by alternating ridges and valleys formed in the first fluted medium. The jacketed wall may further include a second jacket. The second jacket may include a second inner wall, a second outer wall, and a second fluted medium between the second inner wall and the second outer wall. The second fluted medium may form a second plurality of channels. Each channel may be defined by alternating ridges and valleys formed in the second fluted medium.

### CROSS-REFERENCE TO RELATED APPLICATION

This application claims the benefit of priority to US Provisional Patent Application No. 63/743,909, entitled “DEWATERER SYSTEMS AND METHODS,” filed January 10, 2025, the entire contents of which are incorporated herein by reference for all purposes.

### BACKGROUND

The removal of water, or dewatering, is a critical step in many industrial processes, including wastewater treatment, chemical production, and food and beverage manufacturing. Excess water in liquid streams can lead to inefficiencies, increased energy consumption, and complications in downstream operations. Effective dewatering systems are essential for optimizing process performance, reducing operational costs, and improving the quality of final products.

Traditional methods of dewatering include gravity settling, filtration, and evaporation. While these methods are widely used, each has inherent limitations. Gravity settling is often slow and may not achieve the desired level of water removal. Filtration systems can be limited by the particle size distribution and viscosity of the liquid stream, requiring frequent maintenance and filter replacements. Evaporation, which relies on heat to remove water, is energy-intensive and may not be suitable for temperature-sensitive applications.

Liquid streams vary widely in their composition, viscosity, and water content, necessitating adaptable and scalable dewatering systems. The heterogeneity of liquid streams further complicates the design of effective solutions, as systems must be tailored to specific material properties and operational requirements.

There remains a need for advanced systems and methods capable of efficiently and reliably dewatering diverse liquid streams. Such systems should optimize energy use, minimize processing time, and maintain the integrity of the liquid composition. The development of innovative dewatering systems can significantly enhance the sustainability and economic viability of industries reliant on water removal processes.

### BRIEF SUMMARY

Systems and method can effectively remove water from a feed. Distillation cells may be more efficient through a design that includes a first jacket with a fluted medium forming channels within the first jacket. The first jacket can provide structural rigidity while allowing for heat to be transferred from a fluid within the first jacket to the feed being dewatered. A second jacket surrounding the first jacket may also have a fluted medium forming channels within the second jacket. The second jacket may include a material that undergoes a phase change. The phase change material may absorb heat from the first jacket and stabilize temperatures of the reactor. The second jacket may act as a thermal battery and a thermal modulator. A third jacket may surround the first jacket. The third jacket may also have a fluted medium defining channels within the third jacket. The fluted medium may provide integrity and strength cost efficiently. The third jacket may be held at vacuum, which helps insulate the rest of the distillation cell. Through better heat management and materials usage, the systems and methods can be both thermally efficient and cost efficient.

In various embodiments, a system may include a distillation cell. The distillation cell may include a membrane and a jacketed wall. The jacketed wall may include a first jacket. The first jacket may include a first inner wall, a first outer wall, and a first fluted medium between the first inner wall and the first outer wall. The first fluted medium may form a first plurality of channels. Each channel may be defined by alternating ridges and valleys formed in the first fluted medium. The jacketed wall may further include a second jacket. The second jacket may include a second inner wall, a second outer wall, and a second fluted medium between the second inner wall and the second outer wall. The second fluted medium may form a second plurality of channels. Each channel may be defined by alternating ridges and valleys formed in the second fluted medium.

Embodiments may include a method of removing water from a wet feed. The method may include conveying the wet feed into a first portion of a distillation cell. The method may also include raising the temperature of the distillation cell. Raising the temperature of the distillation cell may include flowing a fluid to a first jacket surrounding the distillation cell. Raising the temperature of the distillation cell may include flowing a material undergoing a phase change through a second jacket surrounding the first jacket. The method may further include applying a vacuum to a second portion of the distillation cell. The second portion may be separated by the first portion by a membrane. The method may include transferring water from the wet feed to the second portion of the distillation cell to form a dewatered feed.

### TERMS

"Fluidic communication" refers to the transfer or conveyance of a fluid (liquid or gas) between two or more components, systems, or devices. It encompasses mechanisms, pathways, and interfaces designed to enable the controlled flow of fluid for various purposes, such as functionality, signaling, or energy transfer. Fluidic communication may include conduits or channels or interfaces or connectors.

"Supercritical carbon dioxide" (ScCO₂) refers to a fluid state of carbon dioxide here it is held at or above its critical temperature (304.128 K) and critical pressure (7.3773 MPa).

The term “about” or “approximately” can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term “about” or “approximately” can mean within an order of magnitude, within 5-fold, and more preferably within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%. Any exact number described herein may be modified with “about” or “approximately.”

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3 illustrates a method 300 in accordance with one embodiment

### DETAILED DESCRIPTION

Typical distillation cells for removing water from a feed may be energy-intensive and may not be efficient. Typical distillation cells may be limited in the types of fluids that can be used for temperature control. Materials for distillation cells may not withstand the high pressures, including those for supercritical fluids.

Embodiments of the present invention result in distillation systems with higher thermal efficiencies. These efficiencies may be the result of a jacketed configuration of the distillation cell. The distillation cell may have one or more jackets surrounding the chamber with a feed to be dewatered. Each jacket may have a fluted medium, forming a plurality of channels within the jacket. This configuration allows for structural integrity while using less material than if the jacket was solely an inner wall and an outer wall.

A first inner jacket may include a fluid for temperature control. The jacket may withstand high pressures and/or high temperatures of the fluid.

A second jacket, surrounding the first inner jacket, may include a phase change material. The phase change material (PCM) may include a wax or any material undergoing a phase change. The PCM may moderate temperature changes in the first jacket and in the reaction chamber.

A third jacket may surround the second jacket. The third jacket may be held at vacuum to prevent heat loss from the distillation cell to the surroundings.

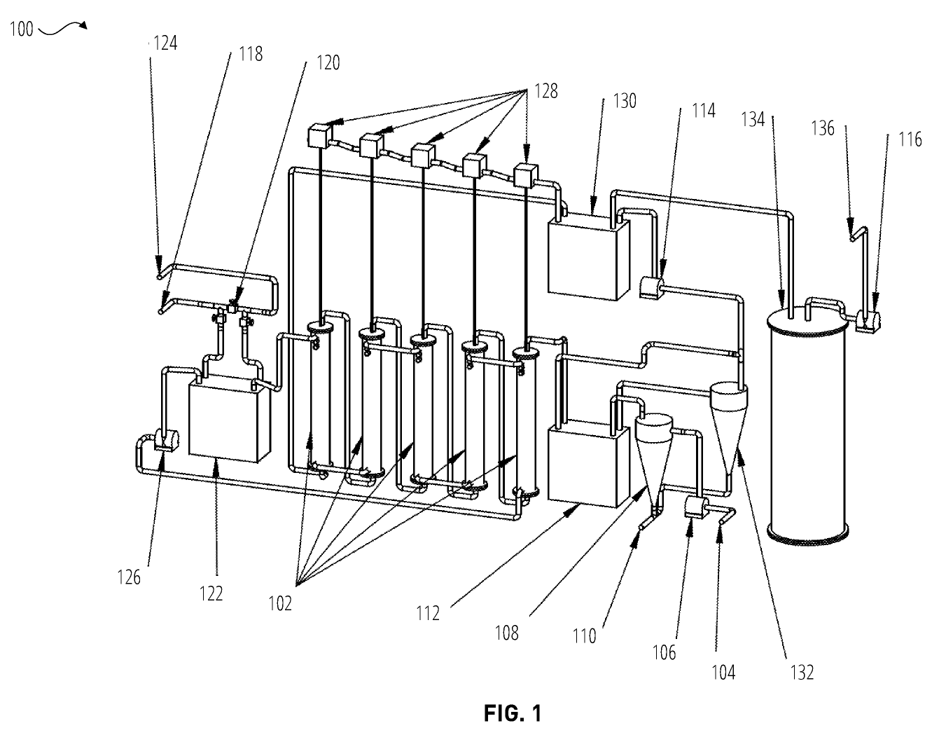

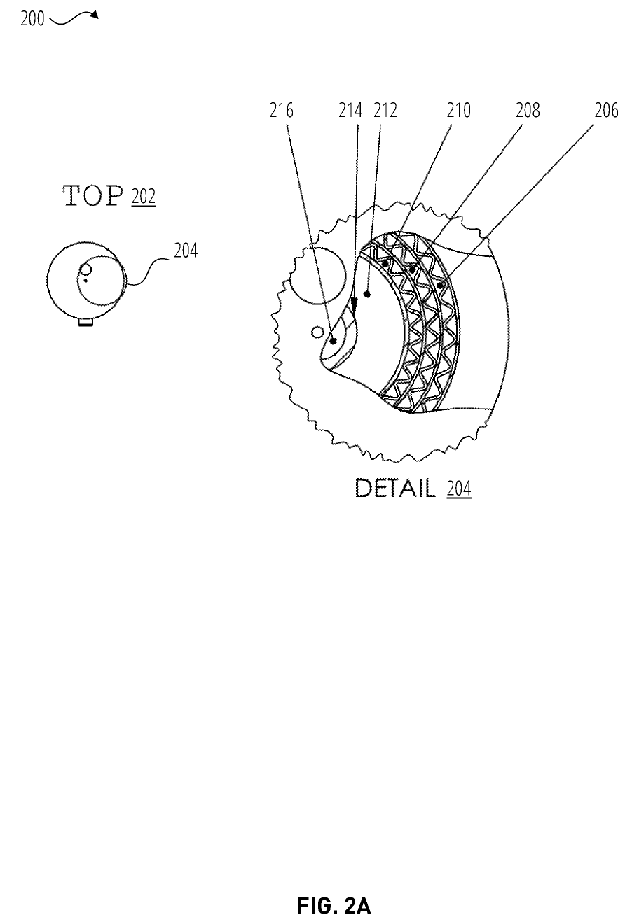

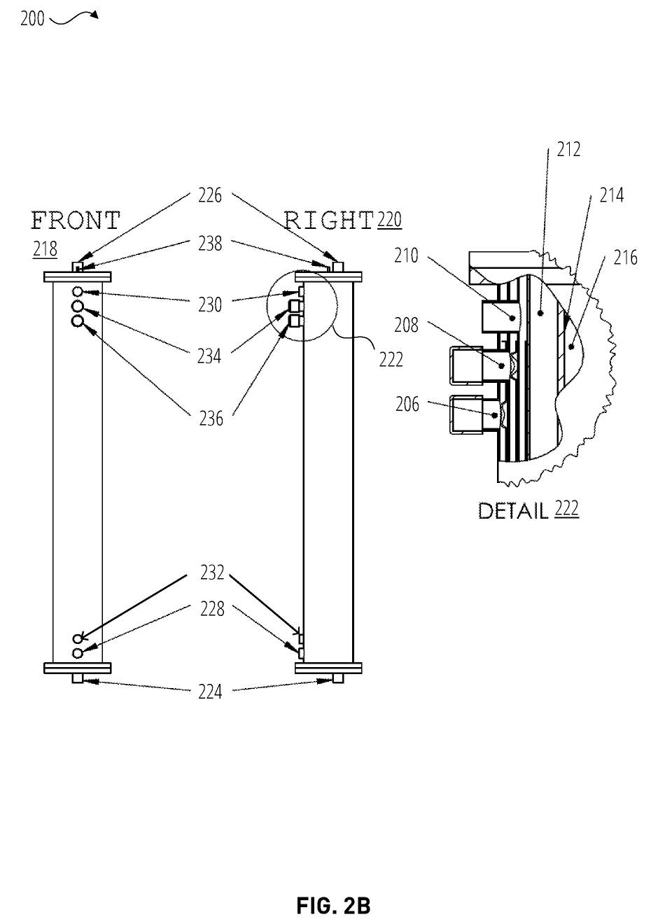

FIG. 1 shows an example system 100 for dewatering a feed (e.g., removing moisture from a feed). The dewatering is aided by vacuum membrane distillation cells 102, which will be described in greater detail with FIG. 2A and FIG. 2B.

Feed materials enter the system at feed inlet 104. Feeds may include a mixture or a solution. Feed may be flowed using feed input pump 106. The feed may have a water (moisture) content of 5% to 10%, 10% to 20%, 20% to 30%, 30% to 40%, 40% to 50%, 50% to 60%, 60% to 70%, 70% to 80%, 80% to 90% by mass. Solids are removed in a feed input cyclone filter 108. The solids exit the system at dewatered product output 110.

The feed liquid after solid separation from feed input cyclone filter 108 is preheated through feed input heat exchanger 112 before joining the feed recirculation loop. Feed recirculation pump 114 drives the feed loop. The feed recirculation loop allows multiple passes of liquid through vacuum membrane distillation cells 102.

Feed materials then flow through a feed material chamber of vacuum membrane distillation cells 102. In FIG. 1, feed materials first enter the left-most vacuum membrane distillation cell 102. Vacuum pump 116 creates a vacuum that creates a vacuum and driving force across the membranes of vacuum membrane distillation cells 102. Vapor (e.g., water) enters the vapor chamber side of the vacuum membrane distillation cells 102.

Vacuum membrane distillation cells 102 are heated by a temperature control fluid. Raising the temperature of the feed materials evaporates water from the feed materials so that the vapor moves across the membrane to the vapor chamber. Hot fluid enters heat input fluid inlet 118. A controlled bypass system 120 channels a controlled amount of the hot fluid to head end preheater heat exchanger 122. The hot fluid then returns to its source through heat input fluid outlet 124.

The temperature control fluid is pumped using temperature control fluid pump 126 through a separate circuit. The temperature control fluid is heated through head end preheater heat exchanger 122 by the hot fluid. The control fluid then passes through each vacuum membrane distillation cell 102, through a corrugated layer in the wall of the cell. This allows efficient thermal transfer to the feed material. The temperature control fluid enters and exits one vacuum membrane distillation cell 102 and then enters and exits the adjacent vacuum membrane distillation cell 102. The series orientation of the distillation cells allows each subsequent cell to process a slightly lower water content, at a slightly lower temperature, and/or a higher pressure. After going through all vacuum membrane distillation cells 102, the temperature control fluid returns to head end preheater heat exchanger 122 to be heated by the hot fluid.

The vapor that moves across the membrane enters the vapor chamber side of vacuum membrane distillation cell 102 then exits to flash boxes 128. The vapor enters the flash boxes 128 through a throttle that allows a pressure differential to build between the vapor chamber of vacuum membrane distillation cell 102 and flash boxes 128. As the vapor enters flash boxes 128, the sudden drop in pressure causes the water vapor to condense.

Feed material that has vapor removed in a first distillation cell of vacuum membrane distillation cells 102 exits the first distillation cell and moves to a second vacuum membrane distillation cell 102. Additional vapor is removed from the feed material in this second vacuum membrane distillation cell 102. The process repeats until the feed material has been dewatered in all vacuum membrane distillation cells 102 (illustrated as five in FIG. 1).

Water following flash boxes 128 enters pure water output heat exchanger 130 (e.g., a recuperator) at the other side. Feed materials driven by feed recirculation pump 114 enter pure water output heat exchanger 130 and have heat recuperated from the pure water output in pure water output heat exchanger 130.

Feed materials after having vapor removed in all vacuum membrane distillation cells 102 enter feed input heat exchanger 112 in one side. The dewatered feed material heats up new input feed material. After exiting feed input heat exchanger 112, the dewatered feed material flows to output cyclone filter 132. Solids and/or concentrated fluids are removed from dewatered feed material in the output cyclone filter 132 while liquids reenter the feed circulation loop to be processed again in vacuum membrane distillation cells 102. The solids and concentrated liquids output of output cyclone filter 132 joins the solids output of feed input cyclone filter 108 and exits at dewatered product output 110.

For water recovery, the condensed water flow from pure water output heat exchanger 130 to pure water collection tank 134. Vacuum pump 116 drives the water to the pure water collection tank 134. Vapor (e.g., non-water vapor) may exit through vapor exhaust 136. Vacuum pump 116 also creates a vacuum through pure water collection tank 134, pure water output heat exchanger 130, flash boxes 128, and the vapor chambers of vacuum membrane distillation cells 102.

FIG. 2A shows vacuum membrane distillation cell 200. Vacuum membrane distillation cell 200 may be any one of vacuum membrane distillation cells 102. The top view 202 of vacuum membrane distillation cell 200 is shown. Circle 204 is shown in detail on the right.

Starting from the outermost layer, vacuum membrane distillation (VMD) cell 200 includes vacuum chamber 206. Vacuum chamber 206 may include a fluted medium inside, similar to corrugation in cardboard. The fluted medium may be a corrugated sheet bonded to the walls or integrally formed with at least one wall (e.g., machined, additively manufactured). The fluted medium may define channels within the chamber. The fluted medium provides structural integrity efficiently. Less material may be used to provide the same structural integrity than if no fluted medium were used.

Adjacent to vacuum chamber 206 is phase change material chamber 208. Phase change material chamber 208 may include a fluted medium defining channels within the chamber. Phase change material chamber 208 may include any material undergoing a change (e.g., a phase change or change from supercritical to non-supercritical). The fluted medium provides structural integrity and improves thermal management. The fluted medium and the rest of phase change material chamber 208 may withstand high pressures (e.g., at least 1,100 psi), which allows for the use of fluids, including ScCO2, at high pressures. Supercritical carbon dioxide may be used as a thermal transfer medium. The phase change material chamber 208 acts as a thermal battery and a thermal modulator. The feed medium may cause thermal fluxes. The PCM may moderate and maintain temperatures for process stability. The PCM may reduce thermal cycling, improving longevity of the distillation cell.

Interior to phase change material chamber 208 is temperature control fluid chamber 210. Temperature control fluid chamber 210 may include a fluted medium defining channels within the chamber. The fluted medium provides structural integrity and improves thermal management. The control fluid may pass through the corrugated layer of temperature control fluid chamber 210 in the wall of the cell. This allows for efficient thermal transfer to adjacent feed material chamber 212. Temperature control fluid chamber 210 may include supercritical carbon dioxide, supercritical steam, a supercritical fluid, a subcritical fluid, a critical fluid, a non-critical fluid, or any suitable fluid.

Interior to temperature control fluid chamber 210 is feed material chamber 212. The feed material chamber 212 is heated by the fluid from temperature control fluid chamber 210. Feed material flows through the feed material chamber.

Interior to feed material chamber 212 is filter membrane 214. Vapor (e.g., water vapor) from the feed material passes through filter membrane 214.

Heat and pressure in the feed material chambers 212 produce water vapor in the vapor chambers 216 through filter membranes 214. The vapor passes to vapor chamber 216, which is interior of filter membrane 214. The feed material may flow through feed material chamber 212 and vapor through vapor chamber 216 in the same direction (e.g., up in FIG. 1).

In some embodiments, vacuum chamber 206 may be surrounded by an additional vacuum chamber wall to reduce thermal losses from the outer wall of vacuum chamber 206 contacting the atmosphere.

FIG. 2B shows a front view 218 and a right view 220 of vacuum membrane distillation cell 200. Circle 222 is shown in detail.

The detailed view of circle 222 shows elements from FIG. 2A but from the side. Vacuum chamber 206, phase change material chamber 208, and temperature control fluid chamber 210 are shown as the outermost layers of vacuum membrane distillation cell 200. The chambers are shown as jackets, in fluid communication with ports. Feed material chamber 212, filter membrane 214, and vapor chamber 216 are also shown. The chambers and membranes are cylinders or annular cylinders.

Front view 218 and right view 220 shown feed inlet 224. Feed inlet 224 may be in fluidic communication with feed material chamber 212. Feed going through vacuum membrane distillation cell 200 may exit through feed outlet 226. The feed exiting feed outlet 226 may enter another vacuum membrane distillation cell or a heat exchanger to heat input feed (e.g., feed input heat exchanger 112).

The temperature control fluid may enter through temperature control fluid port 228, pass through temperature control fluid chamber 210, and exit through temperature control fluid port 230. In some embodiments, the fluid flow may be reversed.

Phase change material (PCM) may enter through PCM chamber port 232, pass through phase change material chamber 208, and exit through PCM chamber port 234. In some embodiments, the PCM flow may be reversed.

Vacuum chamber charge port 236 allows for vacuum chamber 206 to be brought down to vacuum, using a pump.

The vapor exiting the feed material may pass from feed material chamber 212 through filter membrane 214 to vapor chamber 216. The vapor then exits vacuum membrane distillation cell 200 through vapor outlet 238. The vapor then continues to be condensed (e.g., to flash boxes 128).

### Example Systems

Embodiments may include a system. The system may include system 100 or any system described herein.

The system may include a distillation cell including a membrane and a jacketed wall. The distillation cell may include vacuum membrane distillation cell 102, vacuum membrane distillation cell 200, or any distillation cell described herein. The distillation cell may be cylindrical. Accordingly, any or all of the jackets may be an annular cylinder or ring-shaped cylinder.

The jacketed wall may include a first jacket. First jacket may be temperature control fluid chamber 210. The first jacket may include a first inner wall, a first outer wall, and a first fluted medium between the first inner wall and the first outer wall. The distance from the first inner wall to the first outer wall may be 90% to 100%, 100% to 110%, 110% to 120%, 120% to 130%, 130% to 140%, 140% to 150%, or 150% to 200% the thickness of the first inner wall. The first fluted medium may form a first plurality of channels. Each channel may be defined by alternating ridges and valleys formed in the first fluted medium. The first jacket may have a total of 10 to 20, 20 to 30, 30 to 40, 40 to 50, 50 to 100, or over 100 ridges and/or valleys. The amplitude of the ridges and/or valleys may be half the distance between the first inner wall and the first outer wall. The period may be 0.1 to 0.5, 0.5 to 1.0, 1.0 to 1.5, 1 to 2, 2 to 3, 3 to 4, 4 to 5, 5 to 10, or over 10 times the amplitude. A temperature control fluid may be disposed in the first plurality of channels. The temperature control fluid may be a liquid or a gas. The temperature control fluid may include water, glycol (e.g., ethylene glycol, propylene glycol, diethylene glycol, triethylene glycol, butylene glycol), steam, or any suitable medium. The fluid in the first plurality of channels may be at a pressure from atmospheric pressure (e.g., 14.7 psi) to 1,000 psi, 1,000 to 1,100 psi, 1,100 to 1,500 psi, or over 1,500 psi.

The distillation cell may include a first port. The first plurality of channels may be in fluidic communication with the first port. The first port may be temperature control fluid port 230 or temperature control fluid port 228. The first plurality of channels may be in fluidic communication with both ports. The port may be for flowing a fluid into o rout of the first jacket. These ports may receive and send temperature control fluid to a heat exchanger (e.g., head end preheater heat exchanger 122).

The jacketed wall may include a second jacket. The second jacket may be phase change material chamber 208. The second jacket may include a second inner wall, a second outer wall, and a second fluted medium between the second inner wall and the second outer wall. The second fluted medium may form a second plurality of channels. Each channel may be defined by alternating ridges and valleys formed in the second fluted medium. The second inner wall may be the first outer wall. A material undergoing a change (e.g., phase change) may be disposed in the second plurality of channels. The second jacket may be geometrically similar to the first jacket. The second jacket, by surrounding the first jacket, may have a larger inner and outer diameter. In embodiments, the second jacket may have the same distance between the second inner wall and the second outer wall as between the first inner wall and the first outer wall. In embodiments, the distance may be different but may be any of the distances described for the first jacket above. The material may include supercritical carbon dioxide undergoing a change to gaseous carbon dioxide, water (liquid, vapor, supercritical), or a wax. The phase change material (PCM) may add temperature stability to the distillation cell. The PCM in the second plurality of channels may be at a pressure from 1,000 to 1,100 psi, 1,100 to 1,500 psi, or over 1,500 psi. In some embodiments, the second jacket may be at vacuum (e.g., 100 Torr to 10 Torr), without a phase change material.

The distillation cell may include a second port. The second plurality of channels may be in fluidic communication with the second port. The second port may be PCM chamber port 234. The second port may allow injection and/or replacement of the PCM.

The jacketed wall may include a third jacket. The third jacket may be vacuum chamber 206. The third jacket may include a third inner wall, a third outer wall, and a third fluted medium between the third inner wall and the third outer wall. The third fluted medium may form a third plurality of channels. Each channel may be defined by alternating ridges and valleys formed in the third fluted medium. The third inner wall may be the second outer wall. The third plurality of channels may be at vacuum. Vacuum may be in a range from 100 Torr to 10 Torr.

The distillation cell may include a third port. The third plurality of channels may be in fluidic communication with the third port. The third port may allow for evacuation of the third jacket by a pump. The third port may be in fluidic communication with a pump.

The first fluted medium, the second fluted medium, and/or the third fluted medium may include a metal. For example, the metal may be low temperature metals, tin, potassium, gallium, stainless steel, or other alloys.

The distillation cell may include an inlet at a first end and an outlet at a second end. The first end and the second end may be at opposite ends. The inlet may be feed inlet 224. The distillation cell may include two outlets at the second end, one for vapor and one for partially or completely dewatered feed. The outlet may be feed outlet 226 or vapor outlet 238. If the distillation cell is in a vertical orientation, the inlet may be at the bottom and one or more outlets may be at the top.

The system may further include a cyclone filter. The cyclone filter may be feed input cyclone filter 108. The system may further include a heat exchanger in fluidic communication with the cyclone filter. The inlet of the distillation cell may be in fluidic communication with the heat exchanger. The heat exchanger may be feed input heat exchanger 112 or pure water output heat exchanger 130. The distillation cell may be in fluidic communication with a unit operation with another unit operation in between.

The system may further include a collection tank and a heat exchanger. The collection tank may be pure water collection tank 134. The heat exchanger may be pure water output heat exchanger 130.

The membrane may define a first portion and a second portion of the distillation cell. The membrane may be filter membrane 214 or any membrane described herein. Filter membranes may be hydrophobic and/or microporous. Filter membranes may comprise polytetrafluoroethylene (PTFE), polypropylene (PP), polyvinylidene fluoride (PVDF), polyethersulfone (PES), composites, or any suitable polymer or material. The pores may allow for vapor to pass but not a liquid. The first portion may be an annular cylinder proximal to the jacketed wall. The annular cylinder may be feed material chamber 212. The second portion may be a central cylinder. The central cylinder may be vapor chamber 216. The heat exchanger may be in proximal fluidic communication with the second portion. The collection tank may be in distal fluidic communication with the second portion in a continuous process.

The distillation cell may contain a feed. The feed may include any biomass described herein, including any following solids separation by a cyclone filter. The distillation cell may include water vapor from distilling the feed.

The distillation cell may be a first distillation cell. The system may include a plurality of distillation cells. The plurality of distillation cells may include the first distillation cell. Each of the distillation cells may be similar to the first distillation cell. The outlet of one distillation cell may be in fluidic communication with the inlet of an adjacent distillation cell. In some embodiments, the plurality of distillation cells may include the distillation cells in series. In some embodiments, the plurality of distillation cells may include 2, 3, 4, 5, 6, 7, 8, 9, 10, or more than 10 distillation cells.

### Example methods

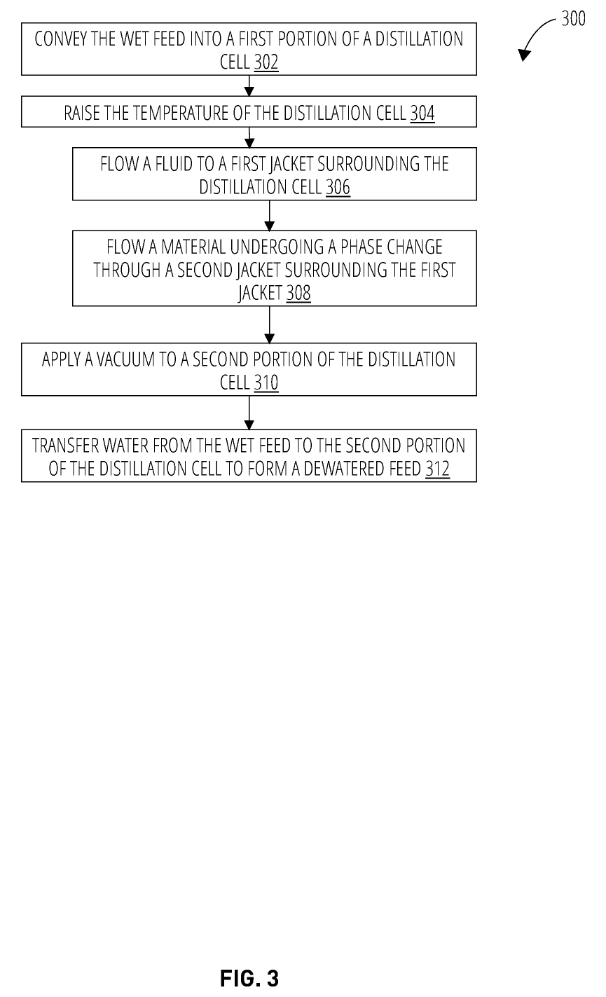

FIG. 3 shows a method 300 of removing water from a wet feed. The feed may include contaminated water, manure, brine, or salt water. Method 300 may be performed by system 100 and components thereof (e.g., vacuum membrane distillation cell 102 or vacuum membrane distillation cell 200) or any system described herein.

In block 302, method 300 conveys the wet feed into a first portion of a distillation cell. The wet feed may first have solids separated following a cyclone filter. The wet feed may be heated above room temperature by a heat exchanger. The wet feed may be any feed described herein. The wet feed may have a water content of 5 to 10%, 10 to 20%, 20 to 30%, 30 to 40%, 40 to 50%, 50 to 60%, 60 to 70%, 70 to 80%, 80 to 90%, or 90 to 95% by mass.

In block 304, method 300 raises the temperature of the distillation cell. The temperature may be in a range from 35 to 40 °C, 40 to 50 °C, 50 to 60 °C, 60 to 70 °C, 70 to 80 °C, 80 to 90 °C, 90 to 100 °C, 100 to 110 °C, or over 110 °C. The temperature may depend on the pressure. Raising the temperature may be by block 306, where method 300 flows a fluid to a first jacket surrounding the distillation cell. Flowing the fluid to the first jacket may include flowing the fluid through a first plurality of channels defined by a first fluted medium. The first jacket may be temperature control fluid chamber 210 or any first jacket described herein. The fluid may be any temperature control fluid described herein. The fluid may be subcritical, supercritical, critical, and non-critical. The supercritical fluid may be supercritical carbon dioxide or supercritical steam. The fluid may be at a pressure of 1,000 to 1,100 psi, 1,100 to 1,200 psi, 1,200 to 1,300 psi, 1,300 to 1,400 psi, 1,400 to 1,500 psi, 1,500 to 2,000 psi, or over 2,000 psi.

Raising the temperature may be by block 308, where method 300 flows a material undergoing a phase change through a second jacket surrounding the first jacket. The material may be supercritical carbon dioxide or any PCM described herein. The fluid may be subcritical, supercritical, critical, and non-critical. The supercritical fluid may be supercritical carbon dioxide or supercritical steam. The fluid may be at a pressure of 1,000 to 1,100 psi, 1,100 to 1,200 psi, 1,200 to 1,300 psi, 1,300 to 1,400 psi, 1,400 to 1,500 psi, 1,500 to 2,000 psi, or over 2,000 psi. Flowing the material undergoing the phase change through the second jacket may include flowing the material through a second plurality of channels defined by a second fluted medium. The second jacket may be phase change material chamber 208 or any second jacket described herein.

Method 300 may further include applying a vacuum to a third jacket surrounding the second jacket. The third jacket may include a third plurality of channels defined by a third fluted medium. The third jacket may be vacuum chamber 206 or any third jacket described herein.

In block 310, method 300 applies a vacuum to a second portion of the distillation cell. The second portion is separated by the first portion by a membrane. The membrane may be any membrane described herein. The first portion may be an annular cylinder, including feed material chamber 212. The second portion may be a central cylinder, including vapor chamber 216. Vacuum may be applied by a pump, including vacuum pump 116. The pressure in the second portion may be in a range from 20 to 50 mbar, 50 to 100 mbar, 100 to 200 mbar, 200 to 300 mbar, 300 to 400 mbar, 400 to 500 mbar, 500 to 600 mbar, 600 to 700 mbar, 700 to 800 mbar, 800 to 900 mbar, or 900 mbar to 1 bar.

In block 312, method 300 transfers water from the wet feed to the second portion of the distillation cell to form a dewatered feed. The water may be transferred by temperature and/or pressure. The water may be transferred in vapor form across the membrane. Liquids may be retained in the first portion. The dewatered feed may have a water content that is from 0 to 10%, 10% to 15%, 15% to 20%, 20% to 30%, 30% to 40% by mass lower on an absolute basis compared to the incoming water content.

Method 300 may further include flowing the water from the second portion of the distillation cell to a heat exchanger. For example, the vapor may be flowed to flash boxes (e.g., flash boxes 128) and then to pure water output heat exchanger 130. Method 300 may include condensing the water.

Method 300 may include transferring the dewatered feed into a cyclone filter (e.g., output cyclone filter 132). Method 300 may further include separating liquid from the dewatered feed in the cyclone filter to form an output feed. Method 300 may include collecting the output feed from an output of the cyclone filter (e.g., dewatered product output 110). Method 300 may include evaporating remaining water from the dewatered feed in an evaporator.

The distillation cell may be a first distillation cell of a plurality of distillation cells. The dewatered feed may be a first dewatered feed. Method 300 may further include flowing the first dewatered feed from the first distillation cell into a second distillation cell of the plurality of distillation cells. Method 300 may include raising the temperature of the second distillation cell. Raising the temperature may include flowing the fluid to a first jacket surrounding the second distillation cell. Raising the temperature may include flowing the material undergoing a phase change through a second jacket surrounding the first jacket surrounding the second distillation cell. The plurality of distillation cells may include 2, 3, 4, 5, 6, 7, 8, 9, 10 or more distillation cells. The feed exiting the plurality of distillation cells may have a water content of 5 to 10%, 10 to 15%, or 15 to 20% by mass.

Method 300 may be coordinated through a control system. The control system may include a computing system. The control system may send instructions and receive data from unit operations, including any component described with system 100, a distillation cell, or a multi-effect distillation unit.

Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

What is claimed is:

1. A system comprising:
a distillation cell comprising a membrane and a jacketed wall,
wherein the jacketed wall comprises:
a first jacket comprising a first inner wall, a first outer wall, and a first fluted medium between the first inner wall and the first outer wall,
wherein:
the first fluted medium forms a first plurality of channels, and
each channel is defined by alternating ridges and valleys formed in the first fluted medium; and
a second jacket comprising a second inner wall, a second outer wall, and a second fluted medium between the second inner wall and the second outer wall,
wherein:
the second fluted medium forms a second plurality of channels, and
each channel is defined by alternating ridges and valleys formed in the second fluted medium.

2. The system of claim 1, wherein the second inner wall is the first outer wall.

3. The system of claim 1, wherein the distillation cell is cylindrical.

4. The system of claim 1, wherein the first fluted medium comprises a metal.

5. The system of claim 1, wherein the jacketed wall further comprises:
a third jacket comprising a third inner wall, a third outer wall, and a third fluted medium between the third inner wall and the third outer wall,
wherein:
the third fluted medium forms a third plurality of channels, and
each channel is defined by alternating ridges and valleys formed in the third fluted medium.

6. The system of claim 5, wherein:
the second inner wall is the first outer wall, and
the third inner wall is the second outer wall.

7. The system of claim 6, further comprising:
a temperature control fluid in the first plurality of channels, and
a material undergoing a phase change in the second plurality of channels, wherein the third plurality of channels is at a pressure less than 100 Torr.

8. The system of claim 1, further comprising supercritical carbon dioxide in the second plurality of channels.

9. The system of claim 1, wherein:
the distillation cell further comprises a first port and a second port,
the first plurality of channels is in fluidic communication with the first port, and
the second plurality of channels is in fluidic communication with the second port.

10. The system of claim 9, wherein:
the distillation cell further comprises an inlet at a first end and an outlet at a second end.

11. The system of claim 1, further comprising:
a plurality of distillation cells, wherein the plurality of distillation cells includes the distillation cell,
wherein an outlet of one distillation cell is in fluidic communication with an inlet of an adjacent distillation cell.

12. The system of claim 1, further comprising:
a cyclone filter, and
a heat exchanger in fluidic communication with the cyclone filter,
wherein:
the distillation cell comprises an inlet, and
the inlet is in fluidic communication with the heat exchanger.

13. The system of claim 1, further comprising:
a collection tank, and
a heat exchanger,
wherein:
the membrane defines a first portion and a second portion of the distillation cell,
the first portion is an annular cylinder proximal to the jacketed wall,
the second portion is a central cylinder,
the heat exchanger is in proximal fluidic communication with the second portion, and
the collection tank is in distal fluidic communication with the second portion.

14. A method of removing water from a wet feed, the method comprising:
conveying the wet feed into a first portion of a distillation cell;
raising the temperature of the distillation cell by:
flowing a fluid to a first jacket surrounding the distillation cell, and
flowing a material undergoing a phase change through a second jacket surrounding the first jacket;
applying a vacuum to a second portion of the distillation cell, wherein the second portion is separated by the first portion by a membrane; and
transferring water from the wet feed to the second portion of the distillation cell to form a dewatered feed.

15. The method of claim 14, wherein the wet feed is biomass.

16. The method of claim 14, wherein:
the distillation cell is a first distillation cell of a plurality of distillation cells, and
the dewatered feed is a first dewatered feed,
the method further comprising:
flowing the first dewatered feed from the first distillation cell into a second distillation cell of the plurality of distillation cells,
raising the temperature of the second distillation cell by:
flowing the fluid to a first jacket surrounding the second distillation cell, and
flowing the material undergoing a phase change through a second jacket surrounding the first jacket surrounding the second distillation cell.

17. The method of claim 16, wherein the plurality of distillation cells comprises at least five distillation cells.

18. The method of claim 14, wherein:
flowing the fluid to the first jacket comprises flowing the fluid through a first plurality of channels defined by a first fluted medium, and
flowing the material undergoing the phase change through the second jacket comprises flowing the material through a second plurality of channels defined by a second fluted medium,
the method further comprising:
applying a vacuum to a third jacket surrounding the second jacket, wherein the third jacket comprises a third plurality of channels defined by a third fluted medium.

19. The method of claim 14, further comprising:
flowing the water from the second portion of the distillation cell to a heat exchanger, and
condensing the water.

20. The method of claim 14, further comprising:
flowing the dewatered feed into a cyclone filter;
separating liquid from the dewatered feed in the cyclone filter to form an output feed, and
collecting the output feed from an output of the cyclone filter.
